(19) United States
(12) Patent Application Publication
(10) Pub. No.: US 2012/0215393 A1
(43) Pub. Date: Aug. 23, 2012

(54) Tugbot

(76) Inventor: Jeff Schiedegger, Jupiter, FL (US)

(21) Appl. No.: 13/396,921

(22) Filed: Feb. 15, 2012

Related U.S. Application Data
(60) Provisional application No. 61/443,012, filed on Feb. 15, 2011.

(51) Int. Cl. B60P 3/11

(52) U.S. Cl. 701/23

(57) ABSTRACT

The instant invention describes a remotely controlled vehicle towing device which allows an individual the ability to tow vehicles, such as airplanes or RV/trailers, without the aid of another person. The tow vehicle comprises a chassis constructed and arranged to hold the internal compartments that make the device function. The device further comprises independent drives which allow for dual speed functionality wherein each of the wheels, or continuous wheel tracks, may be powered at different levels or speeds. The dual speed design allows the device to turn in a variety of directions, including semicircle or turns in the shape of arcs, not achievable by many of the cited prior art references. A main control unit may be utilized to coordinate all functionality. A hand-held remote control device allows the device to be operated remotely.

### CROSS REFERENCE TO RELATED APPLICATION

This application claims priority under 35 USC 119(e) to the U.S. Provisional Application 61/443,012, filed on Feb. 15, 2011, entitled “TUGBOT”, the contents of which are herein incorporated by reference.

### FIELD OF THE INVENTION

The present invention relates to a device capable of moving large vehicles, and more particularly to a remotely operated, electric vehicle which is capable of moving a large transportation vehicle, such as an aircraft, or other moving vehicles.

### BACKGROUND OF THE INVENTION

Moving small aircraft along the ground, whether around the airfield or in a hanger, is frequently necessary when the aircraft needs to be serviced or when not in use. While it is possible to use the airplane's own power to move it from place to place, doing so presents safety issues for those moving the plane. In addition, added wear and stress is placed on the motor while undertaking such short operations. To overcome such problems, aircraft tugs have been invented. Aircraft tugs typically require a user to operate the tugs at the site where the airplane is resting. Having someone available to operate the tug and/or assist in the training of small aircraft owners in the operation of these tugs increases cost. Aviation tugs are typically secured to the axle of the front wheel of a small aircraft to move the aircraft without use of the aircraft engines. Once secured, moving the attached aircraft is limited to forward/backward motions without increasing the risk of damage to the landing gear. Many aviation tugs, therefore, fail to provide sharp turning radii which are typically required in crowded airfields and for reducing the risk of airplane damage.

### DESCRIPTION OF THE PRIOR ART

Aircraft tow vehicles are known in the art. For example, U.S. Pat. No. 4,917,564 describes an aircraft towing vehicle which firmly grips the nose wheel of an aircraft as it is received, without endangering components of the nose wheel undercarriage disposed immediately above, and without the need for the vehicle operator to preposition the nose wheel gripping system, whether with a computer or otherwise. Further, the '564 invention is described as capable of pressure-locking the nose wheel in its secured position on the towing vehicle after the wheel has been fully engaged. Pressure locking is possible because of the clamping force applied to one or more moveable members which are capable of engaging the periphery of the wheel, irrespective of its precise location, so that neither differences in the nominal wheel diameters, nor differences in the diameter of a given wheel size, such as due to wear, affects the clamping force that is applied and, therefore, the tightness of the grip.

U.S. Pat. No. 4,950,121 describes an aircraft tug attached to the nose-wheel tire assembly of an airplane. A tire capturing mechanism comprising a pivoting capture arm and a transversally adjustable crossbar opens to allow positioning of the capturing mechanism around and beneath the portion of the tire that is not in contact with the runway surface. After tire capture is accomplished, the capturing mechanism is elevated off the runway surface by a lifting mechanism, so that the entire portion of the weight of the airplane supported by the tire is borne by the aircraft tug. A universal tire clamping mechanism is employed to secure the tire firmly to the capturing mechanism.

U.S. Pat. No. 5,259,572 describes a vehicle having its own traveling gear for towing an aircraft without a draw tongue. The vehicle has a U-shaped chassis frame recess that is open in the forward direction with a clamping and lifting device arranged therein for the nose-wheels of an aircraft. The clamping and lifting device, which is oscillatingly suspended on the chassis frame, includes a pivoting and lifting ramp, as well as two parallel telescoping arms arranged rigidly on the pivoting and lifting ramp, with telescoping cylinders and with gripping arms, which can be pivoted in and whose nose-wheel contact surfaces are rigidly attached to the gripping arms, and telescopingly adjustable hold-down devices, which are hinged to the support.

U.S. Pat. No. 5,302,075 describes an aircraft tug assembly for moving an aircraft on the ground. The tug assembly includes a self-propelled chassis responsive to operator control. A cradle assembly is pivotally attached to a front portion of the chassis. The cradle assembly has an adjustable nose-wheel receiving apparatus comprising two lateral arms adjustably engaged with a rear gate to define a nose-wheel receiving corral therebetween, with the corral sizable to accommodate varying sized aircraft nose-wheels. The chassis has a winch, or alternatively a telescoping arm, for pulling an aircraft nose-wheel onto the cradle assembly and into the corral. An optional front gate may be used to enclose the nose-wheel within the corral. Hydraulic actuators lift the cradle assembly with the nose-wheel thereon so the tug assembly may move the aircraft without starting the aircraft engine.

U.S. Pat. No. 5,480,274 describes an aircraft tug without a draw tongue, and having a chassis divided by means of an axially parallel buckling axle. The pickup device for the nose landing gear of an aircraft is arranged within the fork-shaped recess of the chassis, which is formed by the lifting rockers. The pickup device includes a lifting platform, a pendulum tie-bar, telescopic arms with gripping arms, a push-out tie-bar, a crossbar, longitudinal swinging arms, and a pendulum pin. The pendulum tie-bar, the lifting platform with the telescopic arms, including the push-out tie-bar and the longitudinal swinging arms, are connected to the lifting rockers of the chassis rear part via coupling members. The pendulum tie-bar has a pendular mounting. Since the height-adjustable telescopic arms are pivotably linked to the lifting platform and to the pendulum tie-bar, they are able to contribute to the pendular movement.

U.S. Pat. No. 5,511,926 describes a self-propelled dolly for the movement of aircraft. The dolly includes a pair of laterally spaced apart first ground-engaging wheels. Each wheel is mounted about a portion of a split first axle mounted in a corresponding pair of spaced apart parallel members of a bifurcated chassis portion. The dolly includes one or more second ground-engaging wheels that are mounted on a second chassis portion pivotally connected to the bifurcated chassis portion about a substantially vertical axis. The second ground-engaging wheels provide steering ability to the dolly, and a handle extending from the second chassis portion permits an operator to control the dolly. A motor and drive train is operatively connected to at least one of the ground-engaging wheels. The bifurcated chassis portion is formed in two sections pivotally connected together about a lateral pivot axis at an intermediate location between the first and second wheels. The sections are lowerable and raisable with respect to the ground at their mutually connected ends. A wheel support is mounted on one of the sections and includes a releasable locking mechanism to maintain the sections in the raised position, in which an aircraft with a wheel thereof supported about ground level by the dolly may be maneuvered.

U.S. Pat. No. 6,352,130 describes a towing apparatus capable of moving aircraft and other work pieces about an airfield or other workspace. The towing apparatus includes a first frame which is rotatable relative to a second frame about a common substantially vertical axis. A wheel assembly is positioned within the first frame and driven by a motor which is also mounted on the first frame. A gripper assembly for engaging the aircraft or other work piece is attached to the second frame. In this manner, the apparatus provides for a towing of aircraft or other work pieces along an axis which is proximate the axis of the wheel assembly. Additionally, it provides for a low center of gravity, significantly enhancing the stability and maneuverability of the apparatus in a towing attitude or a non-towing attitude.

U.S. Pat. No. 6,896,283 describes an aircraft tug hitch assembly which includes deflectable guide plates providing a converging pocket for mechanically positioning a tow bar eyelet with the hitch lock pin. The hitch includes a lock assembly including a lock pin which is mounted on a slidable piston for operator controlled movement between a raised unlocked position and a lower locked position capturing the tow bar eyelet. An indicator ball carried by the piston is observable by the tug operator when the lock assembly is in the unlocked position, but is not visible in the locked position, thereby confirming hitch status without the need for verbal communication with ground personnel.

U.S. Pat. No. 6,942,180 describes a tug device for moving small aircraft having front wheels. A portable drill is connected to a drive wheel and a frame is attached to the wheel. The device is compact and easily assembled for use and disassembled for storage. The device includes a pair of drive wheels and is steerable when a locking latch is released. The locking latch provides rigidity to the device under load.

U.S. Pat. No. 7,726,679 describes an apparatus and method for maneuvering a trailer having jockey wheel assembly comprising a ground engaging wheel rotatably mounted on an axle. The apparatus comprises a link member which is adapted to be pivotally mounted on the jockey wheel assembly adjacent the axle and a lever assembly removably securable to said link and adapted to engage a peripheral surface of the wheel, whereby movement of said lever rotates said wheel.

United States Patent Application 2006/0278756 describes a tug operable to move an airplane. The airplane includes a wheel, a frame, a wheel supporting the frame for movement over ground, and a retainer assembly supported by the frame and engageable with the airplane wheel to connect the tug and the airplane. The retainer assembly may be configurable in a loading condition, in which the airplane wheel is loaded onto and off of the tug, and in a retaining condition, in which the airplane wheel is retained on the tug. The retainer assembly may include a first wall engageable with a front portion of the airplane wheel to limit movement of the airplane wheel relative to the tug in the direction of the first wall, and a second wall positionable in an engaging position, in which the second wall is engageable with a rear portion of the airplane wheel to limit movement of the airplane wheel relative to the tug in the direction of the second wall, and in a ramp position, in which the second wall provides a ramp portion, the airplane wheel being movable on the ramp portion onto and off of the tug.

### SUMMARY OF THE INVENTION

The present invention describes a remotely controlled vehicle towing device which allows an individual the ability to tow vehicles, such as airplanes, recreational vehicles typically used for camping and traveling (RV), or trailers, without the aid of another person. The tow vehicle comprises a chassis constructed and arranged to hold the internal components that make the device function. Coupled to the chassis are independent drive systems which provide the device with dual speed functionality wherein each of the wheels, or continuous wheel tracks, may be powered at different levels or speeds. The dual speed design allows the device to turn in a variety of directions and provide sharp turning radii, including semicircles or turns in the shape of arcs, not achievable by many of the cited prior art references. Additionally, the independent drive systems provide a device having independent steering and ability to rotate 360 degrees about a center line. A hand-held controller allows the device to be operated remotely. The device also contains a lift plate and a mechanism for providing lift. Coupled to the lift plate is a sensor that is constructed and arranged to reduce the speed of the device if a load is placed on the plate.

Accordingly, it is an objective of the instant invention to provide an improved vehicle towing device.

It is a further objective of the instant invention to provide an improved vehicle towing device capable of towing an aircraft.

It is yet another objective of the instant invention to provide an improved vehicle towing device capable of towing an RV or trailer.

It is a further objective of the instant invention to provide a vehicle towing device having independent drive systems.

It is yet another objective of the instant invention to provide a vehicle towing device having independent drive systems which provides dual speed functionality.

It is yet another objective of the instant invention to provide a vehicle towing device having independent drive systems which provides independent steering having the capability to turn 360 degrees about itself.

It is a still further objective of the invention to provide a vehicle towing device which minimizes the side load/stress on an airplane landing gear as the plane is being towed.

It is a further objective of the instant invention to provide a remotely controlled vehicle towing device.

It is yet another objective of the instant invention to provide a vehicle towing device which can be operated by a single individual.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of an illustrative embodiment of a vehicle towing device in accordance with the instant invention and illustrated as a tugbot;

FIG. 2 is a perspective view of the upper portion of the tugbot in accordance with the instant invention;

FIG. 3 illustrates the lower portion, or chassis, of the tugbot in accordance with the instant invention;

FIG. 4 illustrates the bottom surface of the chassis illustrated in FIG. 3;

FIG. 5 illustrates the arrangement of various components coupled to the tugbot in accordance with the instant invention;

FIG. 6 is a perspective view of an illustrative, independent wheel drive system assembly of the tugbot;

FIG. 7A is a perspective view of an illustrative embodiment of a gear box in accordance with the instant invention;

FIG. 7B is a perspective view of an illustrative embodiment of a gear box flange in accordance with the instant invention;

FIG. 8 is a perspective view of an illustrative embodiment of a pillow block bearing;

FIG. 9 is a schematic diagram of perspective view of a hand held remote control device in accordance with the instant invention;

FIG. 10A is a perspective view of the lift plate assembly in accordance with the instant invention;

FIG. 10B is a perspective view of the upper portion of the lift plate assembly illustrated in FIG. 10A in accordance with the instant invention;

FIG. 11 is an exploded view of an illustrative example of a solenoid operated power lift/gravity down hydraulic unit in accordance with the instant invention;

FIG. 12 is a hydraulic circuit diagram of the hydraulic unit illustrated in FIG. 11;

FIG. 13 is a side perspective view of the tugbot in accordance with the instant invention engaged with an airplane;

FIG. 14 is an end perspective view of the tugbot in accordance with the instant invention engaged with an airplane;

FIG. 15 illustrates an illustrative embodiment of an assembly for securing a portion of the tugbot to a portion of an airplane;

FIG. 16 is a perspective view of an illustrative embodiment of a winch assembly in accordance with the instant invention;

FIG. 17 is a perspective view of an alternative embodiment of the tugbot in accordance with the instant invention for attachment to an RV or trailer;

FIG. 18 is a perspective view of the vertical structure illustrated in FIG. 17 for attaching to an RV or trailer;

FIG. 19A illustrates the tugboat illustrated in FIG. 17 engaged with a boat trailer;

FIG. 19B illustrates the tugboat illustrated in FIG. 17 engaged with a boat trailer;

FIG. 19C illustrates the tugboat illustrated in FIG. 17 engaged with an RV;

FIG. 20 is a front view of an alternative embodiment of the vehicle towing device in accordance with the instant invention and illustrated as a tracbot;

FIG. 21 is a perspective view of the tracbot;

FIG. 22 is a second perspective view of the tracbot;

FIG. 23 is a side perspective view of the tracbot.

### DETAILED DESCRIPTION OF THE INVENTION

While the present invention is susceptible of embodiment in various forms, there is shown in the drawings and will hereinafter be described a presently preferred, albeit not limiting, embodiment with the understanding that the present disclosure is to be considered an exemplification of the present invention and is not intended to limit the invention to the specific embodiments illustrated.

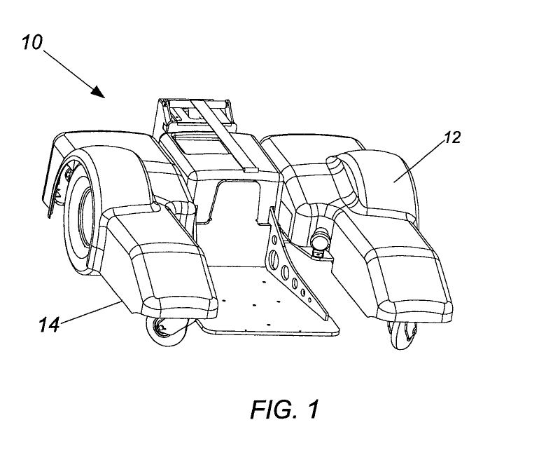

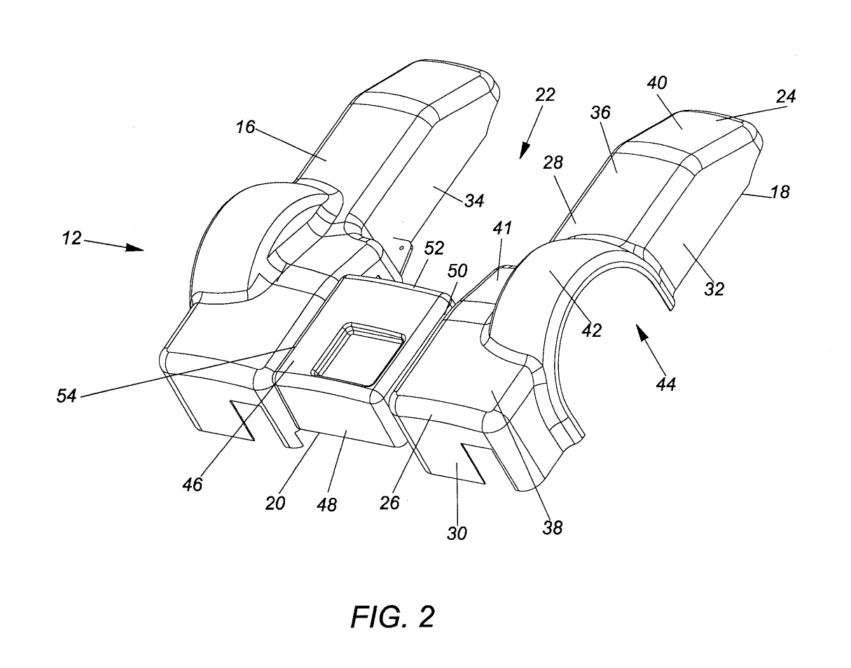

Referring to FIG. 1, an illustrative embodiment of the vehicle towing device is illustrated herein as a tugbot and shown generally as 10. The tugbot 10 comprises an upper portion 12 constructed and arranged to enclose a lower support frame 14. FIG. 2 is a perspective view of the upper portion 12. The upper portion 12 has a generally U-shaped configuration having a left arm portion 16 and a right arm portion 18 connected by a middle portion 20 which forms a generally linear instead of curved base of the U shape. The interior portion 22 of the U-shaped configuration is sized and shaped to allow for coupling of the tugbot 10 with a vehicle, such as the front landing wheel of an airplane, or vehicle attachment. Each of the arm portions 16 and 18 are constructed in the same manner and have a first end 24 and a second end 26, an upper surface 28, and side walls 30, 32 and 34. The upper surface 28 contains generally planar surfaces, 36 and 38, angled surfaces 40 and 41, and a curved surface 42. The curved surface 42 and open area 44 are constructed to partially enclose wheels. The middle portion 20 contains an upper surface 46 and a plurality of side walls 48, 50, 52 and 54.

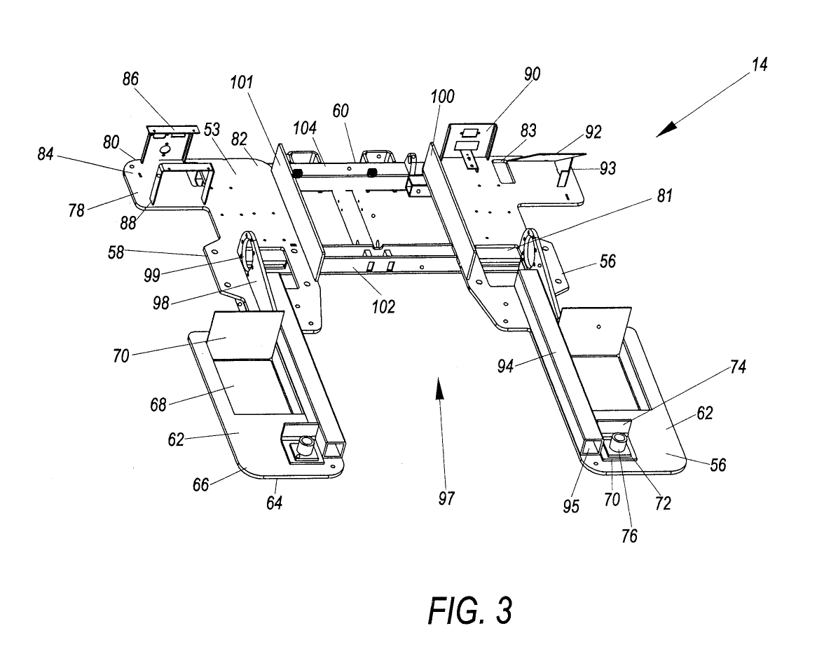

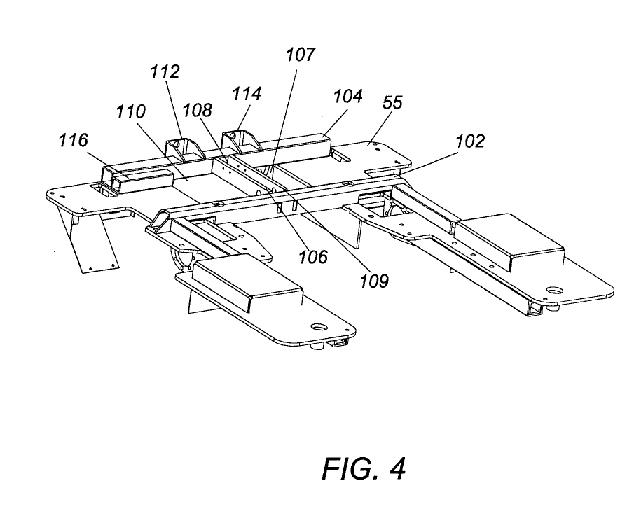

FIGS. 3 and 4 illustrate the lower portion or chassis 14 of the tugbot 10. The chassis 14 is preferably constructed of a single piece of metal, such as steel, and formed with one or more compartments that are constructed and arranged to hold various components of the tugbot 10. The bottom chassis 14 is constructed and arranged in a similar U-shaped configuration as described for the upper portion. The chassis 14 contains a top surface 53 (FIG. 3) and a bottom surface 55 (FIG. 4), a left chassis support arm 56, and a right chassis support arm 58 separated by the chassis middle section 60. Each of the arms 56 and 58 contain a plurality of additional structures, either constructed as part of the main U-shaped configuration or as add-on components coupled to the chassis for support and/or for housing the tugbot 10 function producing components, i.e. motors, batteries, chargers, controllers, and the like.

For example, the left chassis support arm 56 and the right chassis support arm 58 contain a first planar surface 62 having a front edge 64 which defines the first end 66 of chassis 14. The first planar surface 62, illustrated herein as having a generally rectangular shape contains a recessed portion 68 which is constructed and arranged to hold one or more components of the tugboat 10 function producing components. Coupled to the recessed portion 68 is a vertically aligned plate member 70. Near the front edge 64 is a plate 72 coupled to an L-shaped plate 74 which is part of a caster wheel assembly, (described later). A cylindrical member 76 is constructed and arranged to couple with a caster wheel assembly.

A second planar surface 78, illustrated herein as having a generally irregular shape, is constructed and arranged to contain one or more cut-out regions and functions to hold one or more components of the tugboat 10 function producing components. The edge 80 of the second planar surface 78 defines the second end 82 of the chassis 14. A first opening is sized and shaped to hold and secure a gear box transmission. A second opening 83 may also be included and positioned near edge 80. Other function producing components can be attached or coupled to the chassis 14. As illustrated, area 84 bounded by structure 86 and 88 can be used to secure a charging device to the second planar surface 78 of the right chassis support arm 58. The left chassis support arm 56 contains structure 90 which can be used to secure a second charger. An outwardly arranged structure 92 supported by support element 93 can be used to couple a control device to the chassis. Both the left chassis support arm 56 and the right chassis support arm 58 contain an elongated, generally rectangular member 94 positioned near the inner portions, i.e. closest to the area 97 where the airplane wheel contacts the tugbot 10. While the rectangular member 94 is illustrated as having a hollow interior 95, but may include a solid or semi-solid interior. Aligned in a parallel fashion relative to the rectangular member 94 is gear box mount structure 98. Structure 98 contains opening 99 at one of its ends and can be used in securing the wheels to the gear box.

The chassis middle section 60 is defined by two vertically aligned plates 100 and 101. The plates 100 and 101 are arranged in a parallel manner and are coupled to the edge of the left and right chassis arms facing the area 97. Referring to FIGS. 3 and 4, two beam-like structures, 102 and 104 are coupled to the back surface 55 of the chassis 14. Two parallel arranged plates 106 and 108 divide the chassis middle section 60 into a plurality of open spaces, 107, 109, and 110, see FIG. 4. Attached to the beam 104 are two clamps 112 and 114. A smaller rectangular member 116 is aligned next to the beam 104 and partially extends into the opening 110.

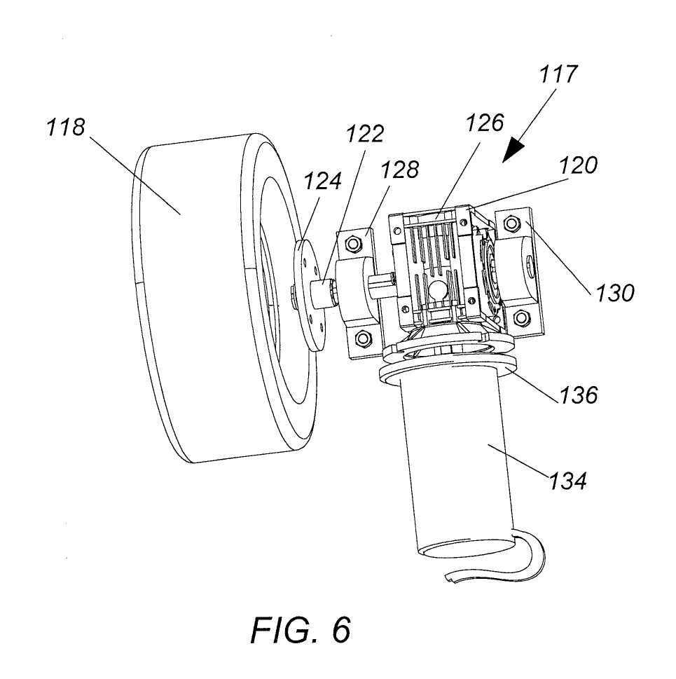

The tugbot 10 in accordance with instant invention distinguishes over the cited prior art in several manners. One of the unique features of the instant invention is the use of independent wheel drive system assemblies. By providing for such features, the tugbot 10 can be maneuvered in various directions not described or contemplated by the cited prior art. By having independent drives, each of the drives can operate at individual speeds, thereby providing a device having dual speed capability. Depending on the need of the user, the two speeds can be the same or different. Differing speeds further provide the tugbot 10 the ability to turn in different radii, such as but not limited to semi-circle or arc turn movement. Such arc turning capability minimizes the side load or side stress placed on the planes landing gear. Moreover, the independent drives provide a device having independent steering, thereby allowing 360 degree steering about itself or a center line. FIG. 6 is an illustrative embodiment of one of the independent wheel drive system assembly 117 of the tugbot. The maneuvering in various directions is aided by use of a wheel 118. The wheel 118 is coupled to a gear box transmission 120 through axle 122 and axle hub 124. The gear box 120 utilizes gearing mechanisms 126, such as worm gears, to drive the axle and rotate the wheel 118. Double pillow block bearings 128 and 130 are used to extend the life of the gear box 120 by minimizing the load and reducing the rotational shear on the gear box. The gear box 120 may contain bearings 130 and 132 (not illustrated). A motor 134 is coupled to the gear box 120 through a flange 136 and used to generate the necessary power to rotate the wheel 118. The motor may further be coupled to a battery and a control unit (not illustrated) which can be designed to control functionality of the device. Each of the components are attached or coupled to a frame using attachment mechanisms, such as, but not limited to, nuts and bolts, clips, or semi-permanent attachment means such as welding.

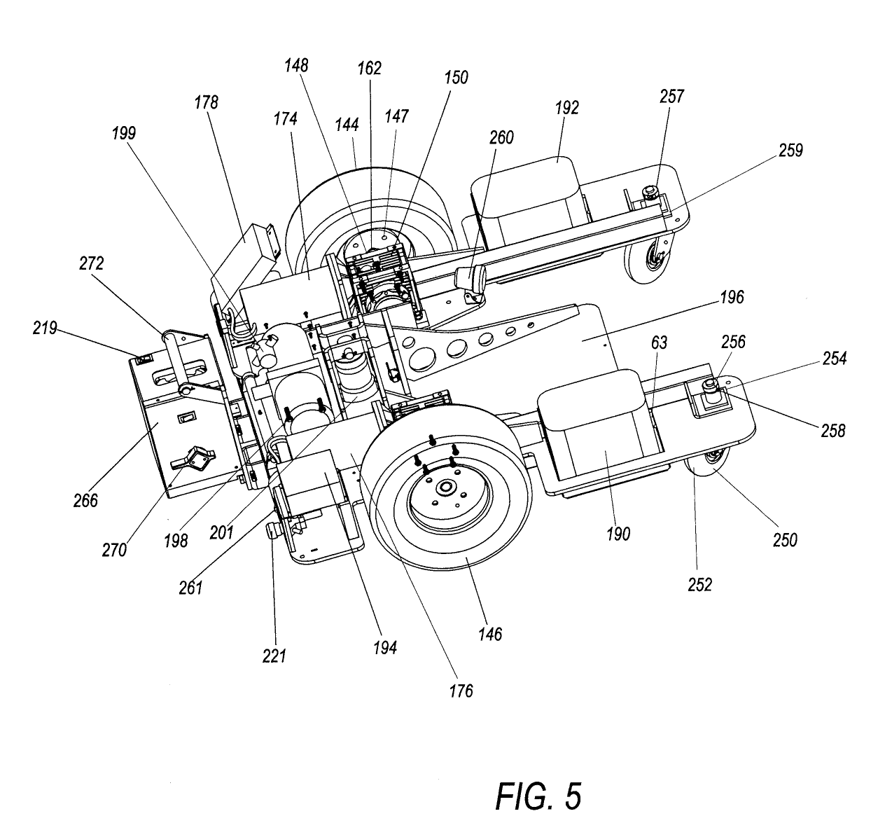

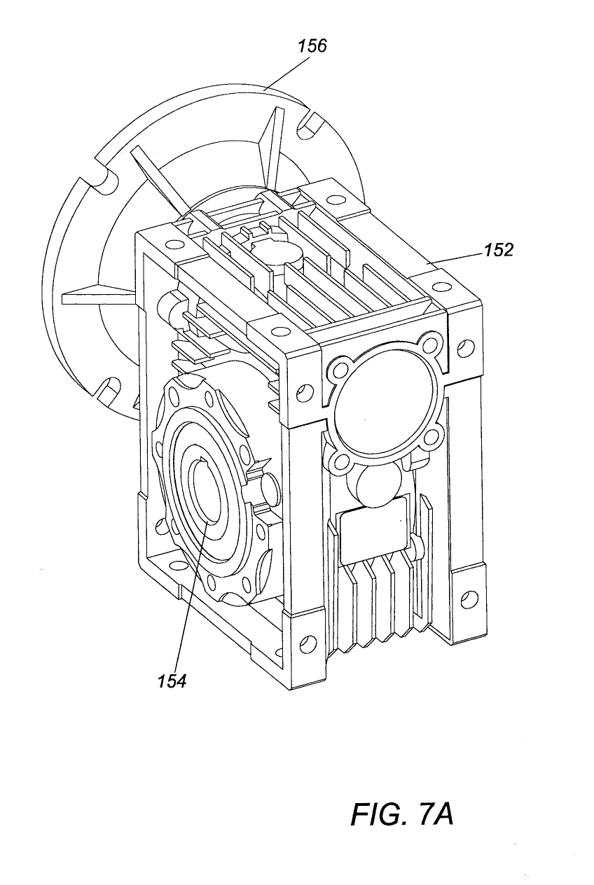

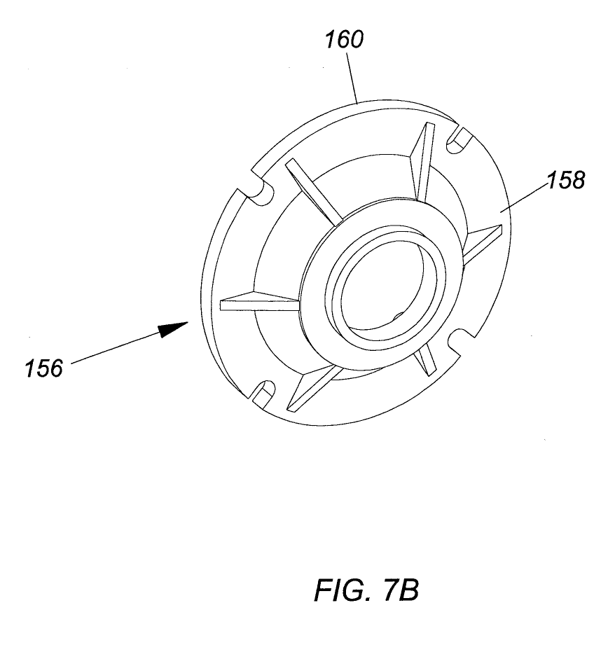

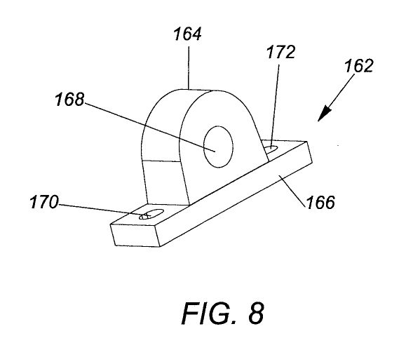

Referring to FIG. 5, the tugbot 10 is shown with upper portion or cover 12 removed, illustrating a non-limiting arrangement of the internal components of the tugbot. Coupled to the chassis 14 is a first left wheel 144 and a first right wheel 146. Each of the wheels 144 and 146 are part of a wheel assembly which are identical in nature. Accordingly, while the wheel assembly associated with the first right wheel 144 will be described, such description applies to the wheel assembly associated with the first left wheel 146. The wheel assembly includes a hub 147 and one or more shafts 148 coupling the wheel 144 to a gear box 150. FIG. 7A is a perspective view of an illustrative example of the gear box 150. The gear box 150 contains a housing 152 holding one or more gearing mechanisms, such as but not limited to, worm gears (not illustrated). A central opening 154 is sized and shaped to receive an axle shaft which is coupled to the gearing mechanisms through one or more bearings (not illustrated). As illustrated, the central opening 154 allows the axle shaft to pass through the gear box 150 A mounting flange 156 has a first surface 158 for coupling to the gear box housing 152 and a second surface 160, see FIG. 7B, for coupling to a motor. Placed between the wheel 144 and the gear box housing 152 is one or more, preferably two, pillow box bearing 162. Referring to FIG. 8, an illustrative example of a pillow block bearing utilized in the wheel drive system assembly 117 is illustrated. The pillow block bearing 162 comprises a rounded member 164 coupled to a generally rectangular member 166. A central opening 168 is sized and shaped to fit an axel shaft. Openings 170 and 172 are sized and shaped to receive screws for securing the pillow block bearing to another object. The use of pillow block bearings prevents or minimizes load or rotational shear placed on the gear box, thereby preventing, or minimizing, the gear box from being damaged. None of the cited prior art, however, contemplates use of minimizing the wear on the gear box in this manner.

Coupled to the flange 156 of the gear box 152 of the wheel assembly is a motor 174, see FIG. 5, (motor 176 corresponds to the wheel assembly for the right side of the tugbot 10). The motor is preferably a 24V DC motor, however, other types of motors such as combustion motors/engines using hydrocarbons, such as gasoline or diesel, hydraulic motors, or solar power motors may be used. The amount of power to each of the wheel assemblies can be controlled by a main control unit 178 coupled to the chassis 14 through securing devices such as screws, nuts and washers. While the main control unit 178 can be placed anywhere, in a preferred embodiment, the main control unit 178 is secured to the main control unit support structure 92, see FIG. 3. In an illustrative example, the main control unit 178 is a high performance dual channel forward/reverse brushed DC motor controller with USB and encoder inputs manufactured by RoboteQ (Scottsdale, Ariz.), such as model number HDC245 or AX2550.

The main control unit 178 can be designed to convert command transmitting devices, such as but not limited to an RC radio, analog joystick, wireless modems, and computing devices such as personal computers or microcomputers. The main control unit 178 is designed to interface directly with high power DC motors in computer controlled or remote controlled mobile devices and automated vehicle applications. The main control unit 178 may include a high performance microcomputer and quadrature encoder inputs to perform advanced motion control algorithms in open or close loop modes (speed or position). The main control unit 178 may further contain a high number of analog, pulse, and digital I/Os which can be remapped as command or feedback inputs, limit switches, or other functions. The main control unit preferably contains two motor channels that can be operated either independently or mixed to set direction and rotation of the tugbot 10 by coordinating the motion of each motor.

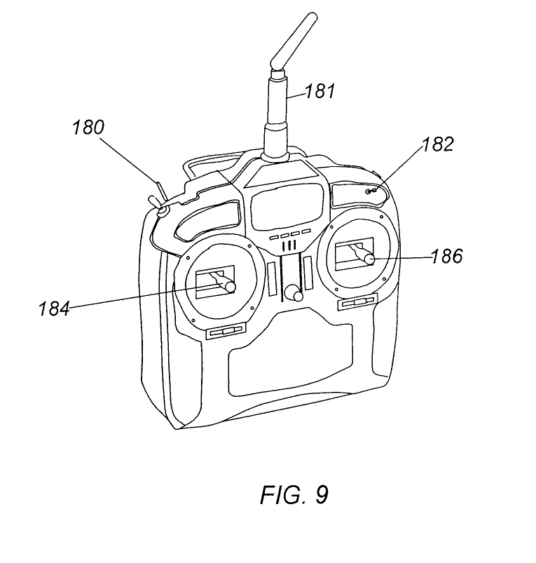

To perform the function of moving a vehicle, such as an aircraft, remotely, the main control unit 178 can be designed to receive/transmit signals to a hand-held remote control device 180. Referring to FIG. 9, a perspective view of an illustrative hand-held remote control device is shown. The hand-held remote control device 180 may contain an antenna 181 for sending and receiving signals such as radio waves, a power button 182 to turn on/off the unit, as well as individual vehicle control units, such as joysticks 184, 186 which independently control the amount of power to each of the left and right motors and controls the direction of movement of the tugbot 10. The device may include a steering device, such as a rotatable knob or ball, for providing the same or additional functions. The joysticks or steering device may also be constructed in such a manner that, depending on the direction of turn, more or less power will be generated, thereby increasing/decreasing the speed to each of the wheels. Other devices, such as other joysticks, steering wheels, or buttons may be used in conjunction with, or in place of, the joysticks 184 and 186. In any configuration, the hand-held remote control device allows the user the ability to operate the tugbot 10 remotely, without being tethered to the vehicle.

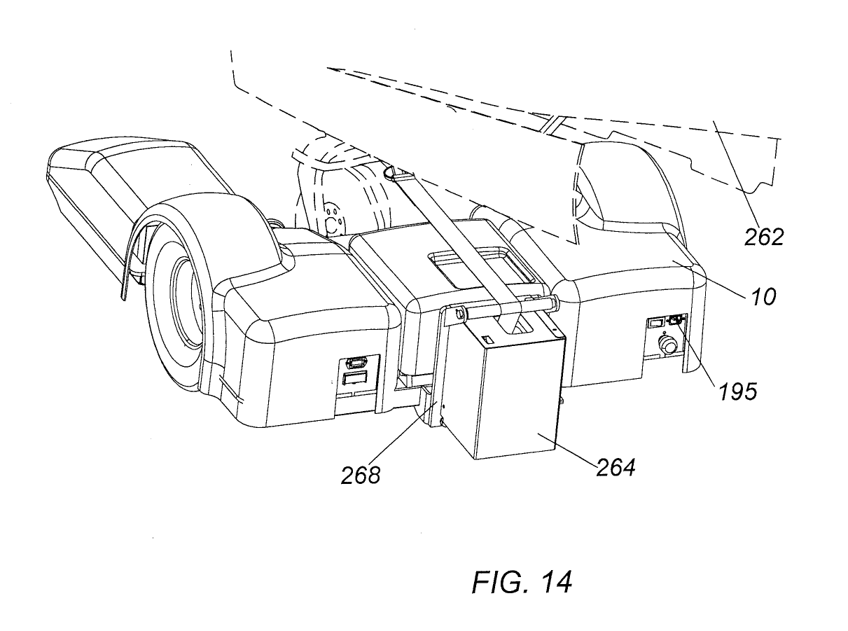

Referring back to FIG. 5, batteries 190 and 192 are positioned within the recessed portion 68 located on the left chassis support arm 56 and the right chassis support arm 58. The positioning of the batteries 190 and 192 provides counter balance support and are electrically coupled, directly or indirectly, to various components of the tugbot 10, such as the main control unit 178, the motors 174 and 176, and other devices that require a power source for operation. Tugbot 10 further contains one or more charging devices 194 with electrical insert 195, see FIG. 14, electrically coupled to each of the batteries 190 and 192.

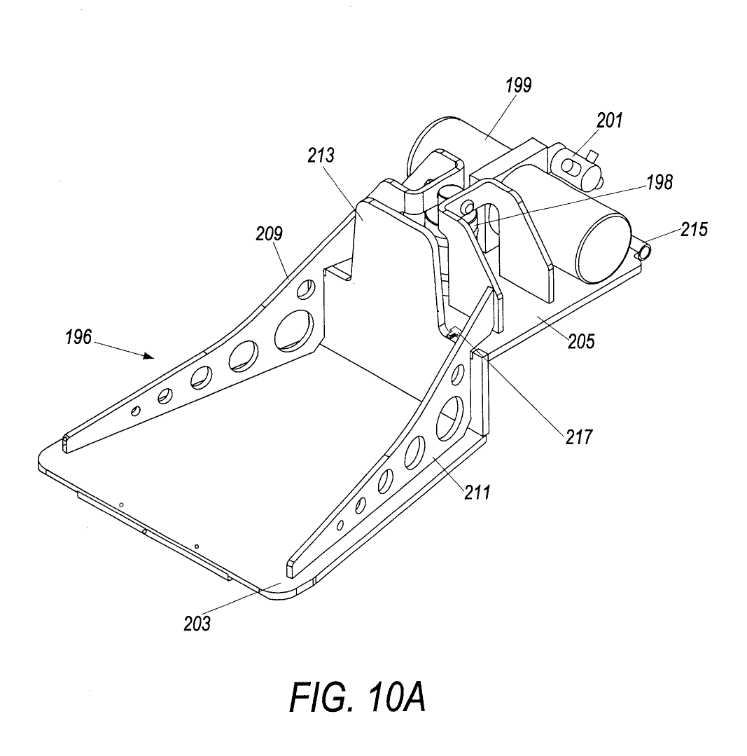

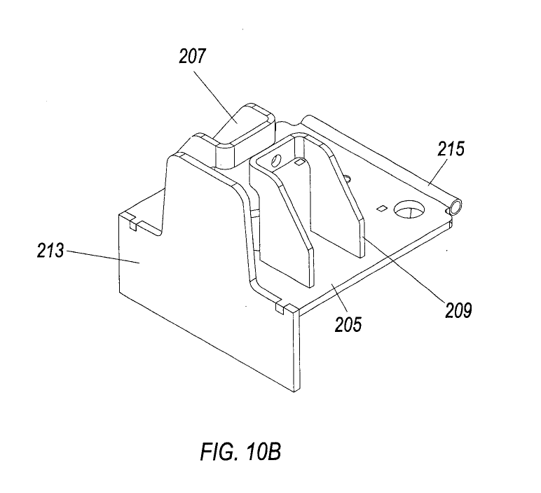

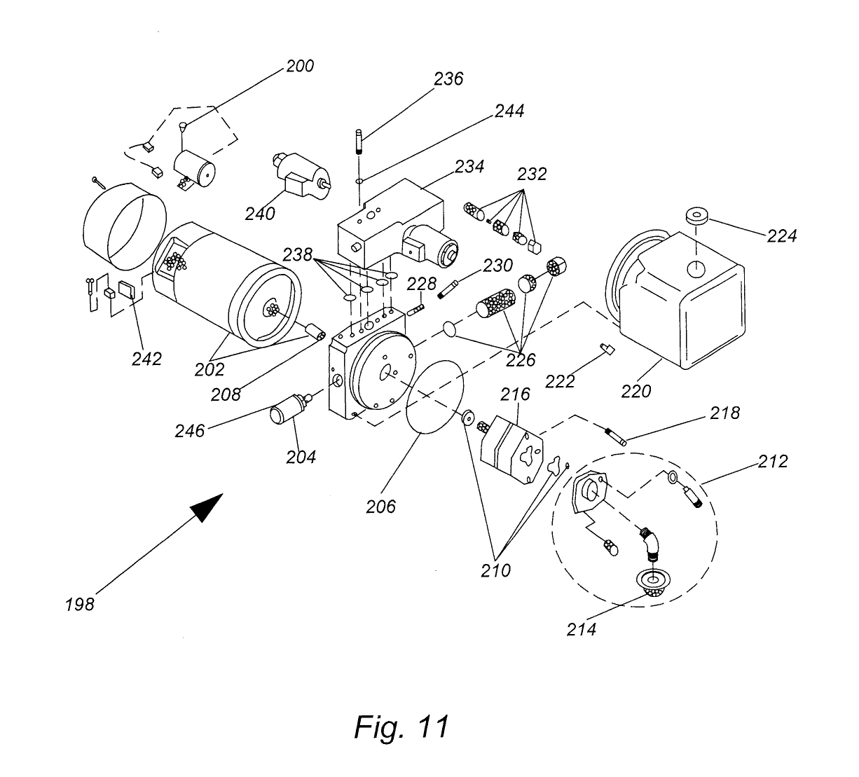

Attached to the middle portion 60 is a lift plate assembly 196 and the necessary hardware to mount the lift plate assembly to the chassis 14. In addition to the lift plate assembly 196 illustrated in FIG. 5, the lift plate assembly 196 can be coupled to lift mechanisms known to one of skill in the art which are designed to provide the lift plate assembly 196 the ability to traverse from a first resting position on the ground to a second position which is elevated from the ground. As an illustrative example, the lifting mechanism may generally include a hydraulic power pack 198 for providing hydraulic lift, such as a power lift and down power unit, see FIG. 11, such as a hydraulic RAM, a solenoid starter 199, and a hydraulic RAM 201. Referring to FIG. 10A, the lifting plate assembly 196 comprises a lower plate 203 which is sized and shaped to receive an object, such as the tire of an airplane. A second upper plate 205 is constructed and arranged to hold the lifting mechanism units (hydraulic power lift and down power unit 198, a solenoid relief 199, and a solenoid starter 201) through structures 207 and 209, see FIG. 10B. Lifting plate gussets 211 are positioned at or near the edges of lower plate 203. One end of the lifting plate gussets 211 is attached to the upper plate 205. A vehicle stop plate 213 forms a right angle with the lower plate 203 and is used to prevent on object, which enters the lower plate 203, from contacting the upper plate 205. Attached to the upper plate 205 is a lifting plate hinge pin 215. The lifting plate assembly 196 may optionally include sensor 217. The lift plate may be operated at a distance through the use of a remote control or may be operated through the use of a power switch (not illustrated) which powers the plate to traverse from a first resting position, on the ground, to a second position off the ground.

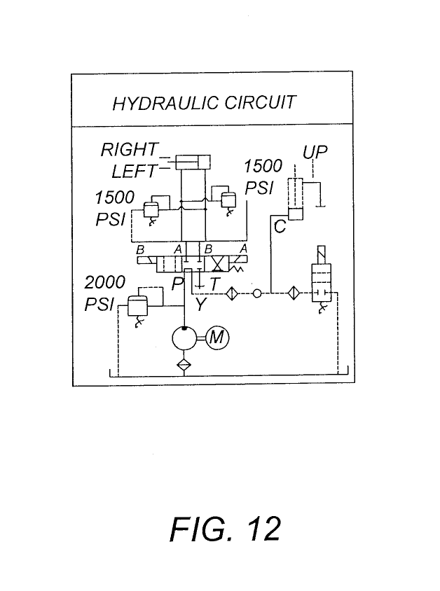

FIG. 11 is an exploded view of an illustrative example of a 12V DC solenoid operated power lift/gravity down unit 198 which may be used as a lifting mechanism for the lift plate assembly 196. The unit 198 includes the following components: a start switch assembly 200, a 12V DC motor 202, a valve 204, a reservoir O-ring 206, coupling 208, pump O-ring kit 210, inlet plumbing kit 212, a filter 214, a gear pump assembly 216, a pump mounting bolt 218, a reservoir 220 for holding hydraulic fluid, a reservoir screw 222, a breather 224, an adjustable relieve valve 226, a spring and ball assembly 228, a valve check 230, a relief valve 232, a U-valve 234, a bolt 236, a U-valve O-ring 238, a solenoid 240, a motor brush 242, a lock washer 244, and a coil 246. FIG. 12 is a hydraulic circuit diagram of the hydraulic unit illustrated in FIG. 11.

Referring back to FIG. 5, the chassis 14 contains a left and a right caster wheel assembly 250 comprising a tire 252 constructed of a material that does not mark or mar surfaces, a bearing backing plate 254, a castor stem 256, a castor shaft collar 257, and a castor stem tube 258 all secured to the chassis through castor bracket 259. Other components not illustrated may include bearings, supports, pins, collars, and support brackets. The chassis 14 may optionally include one or more light sources 260, such as but not limited to, LED compact work lamps. The light source 260 may be operated at a distance through the use of the remote control or may be manually operated through the use of a light switch 261.

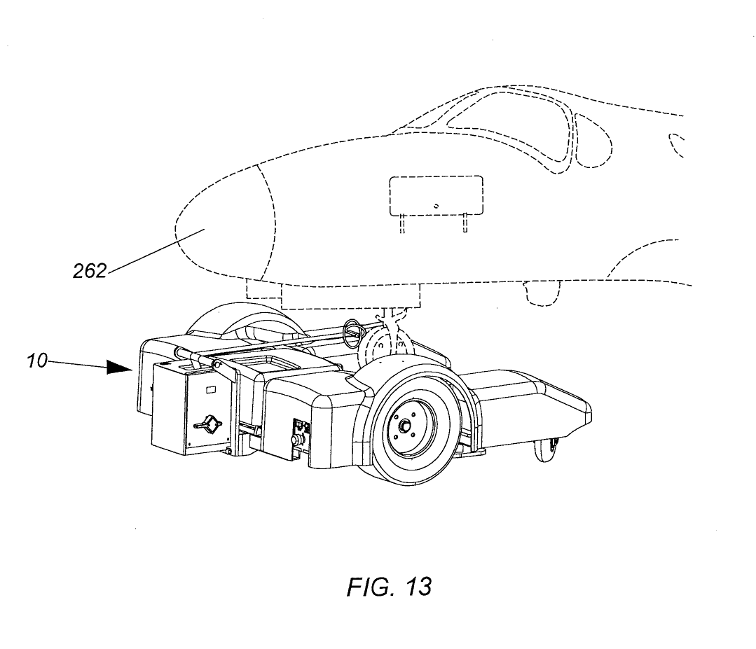

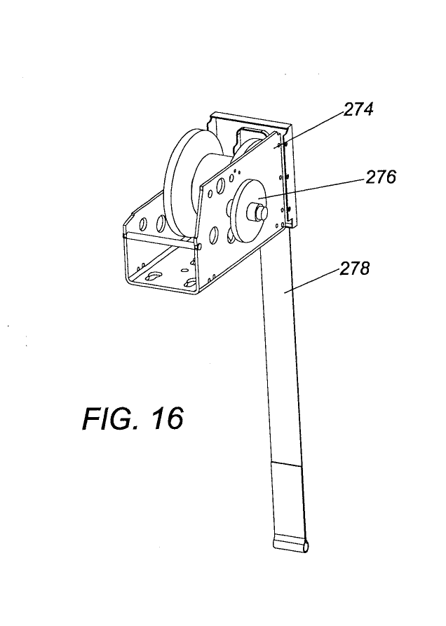

In use, the tugbot 10 is designed to allow operation of the device with only a single person. FIGS. 13 illustrates the tugbot 10 coupled to an airplane 262. In this position, the tugbot 10 is capable of moving the airplane into a desired location. Referring to FIG. 14, a winch assembly cover 264 is illustrated, coupled to the center portion 60 of chassis 14. The winch assembly cover 264 houses a winch assembly which is coupled to the chassis 14 through a support structure 266, see FIG. 5 and mounting plate 268, FIG. 14. The support structure includes a winch clutch lever 270 and a strap, cable, or rope support device 272. The winch assembly, illustrated in FIG. 16, includes a base support structure 274 and a winch wheel 276 for adjusting the tension of a strap 278. The winch assembly further includes a gearing mechanism and motor (not illustrated) for providing more or less tension on the strap 278. The winch assembly 276 may be operated remotely through the use of the remote control or may be operated on site through the use of a power switch (not illustrated). The winch assembly shown herein is an illustrative example only. Other mechanical devices designed to pull in or let out, or otherwise adjust the tension of the strap, cable, or rope known to one of skill in the art can be used.

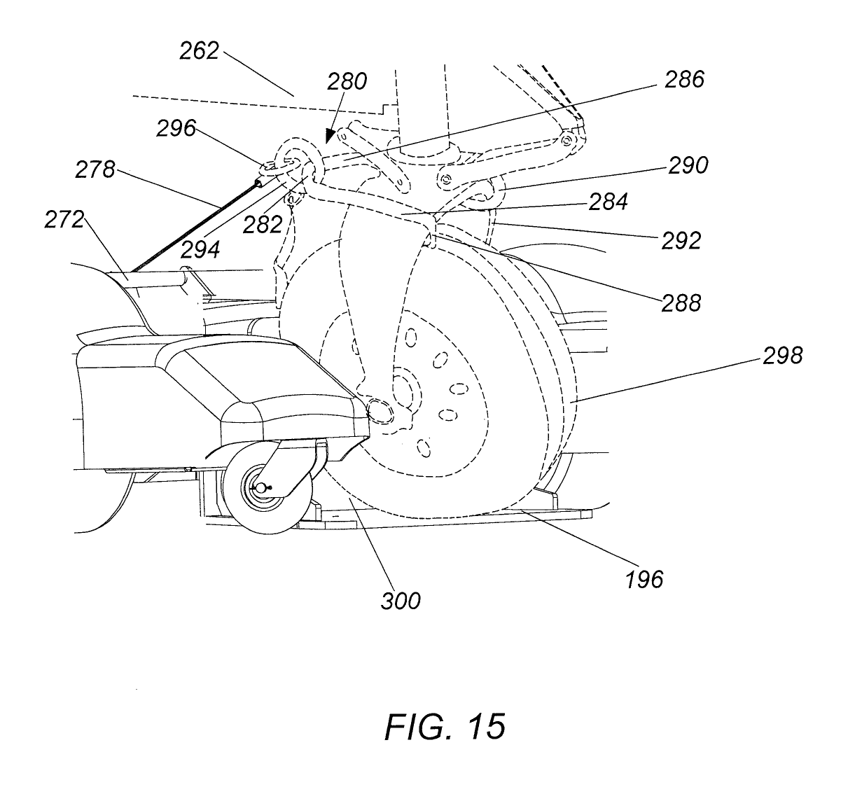

Coupled to one end of the winch strap 278 is a securing assembly for securing the winch strap 278 to the aircraft, see for example FIG. 15. The securing assembly, illustrated herein comprises a generally U-shaped hook 280 having a first end 282 which is generally V-shaped, a middle portion containing two parallel rod shaped members 284 and 286, and two generally U-shaped ends 288 and 290. The U-shaped ends 288 and 290 are constructed and arranged to engage the upper portion of a nose fork assembly 292 of the airplane 262. The ends 288 and 290 turn inwardly towards a ring 294 which is coupled to the V-shaped first end 282. The ring 294 is coupled to the winch strap 278 through an attachment member, illustrated herein as a safety hook 296. While the securing device as illustrated is designed to secure the tugbot 10 to the nose fork assembly, devices securing to the wheel or other potions of the plane can be used, and may include other types of hooks or clasps.

As illustrated in FIG. 15, the wheel 298 of the airplane 262 rests on the lift plate assembly 196. The lift plate assembly 196 may include an alignment member 300 which allows the user the ability to properly align the wheel onto, for example, the center of the lift plate or along the strongest portion of the plate. In addition, coupled to the lift plate assembly 196, or other parts of the chassis 14, is a sensor (see 217 on FIG. 10A). The sensor, which may be electrically coupled to the main control unit 178, is constructed and arranged to sense one or more characteristics, such as load, i.e. the weight of the airplane tire or a person placed on the lift plate, presence of an object, i.e. an ultrasonic sensor which detects the present of an object within the loading zone (lower plate 203) of the lifting plate assembly, temperature, light, motion, or the like. Upon sensing a desired presence or load, the sensor which may be electrically coupled to the control unit may send a signal to the control unit so that the power or output voltage driving the tugboat 10 can be cut or reduced. Therefore, if the sensor detects a presence or load, the normal traveling speed of the tugboat of, for example, 10 miles per hour without a load will be cut to 5 miles per hour until the load has been removed. In this manner, the tugbot 10 moves in a safe, secure and controlled manner when an aircraft is attached, thereby minimizes damage, particularly against lateral loads to the aircraft, as it is being transported. The tugbot 10 may include a push button emergency stop (E-stop) 221, see FIG. 5, which instantly cuts power to the device in situations where the tugbot 10 requires instantaneous disablement.

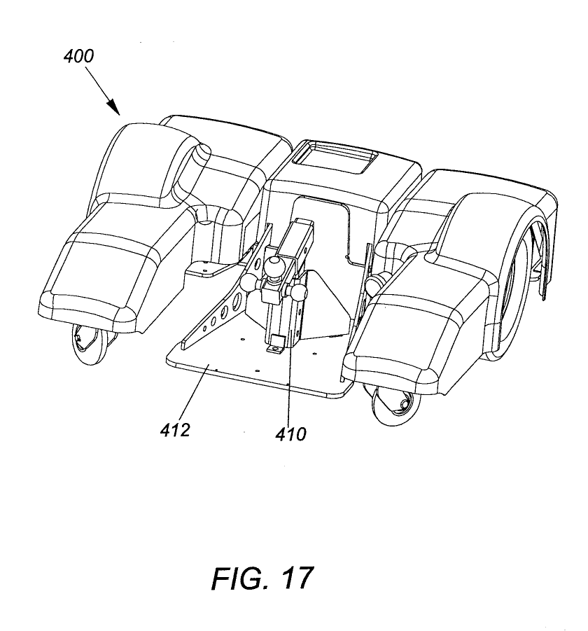

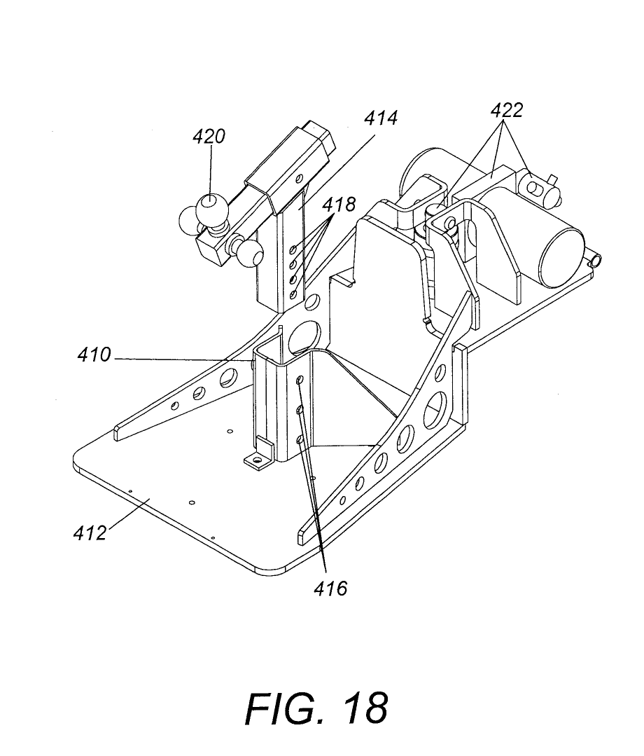

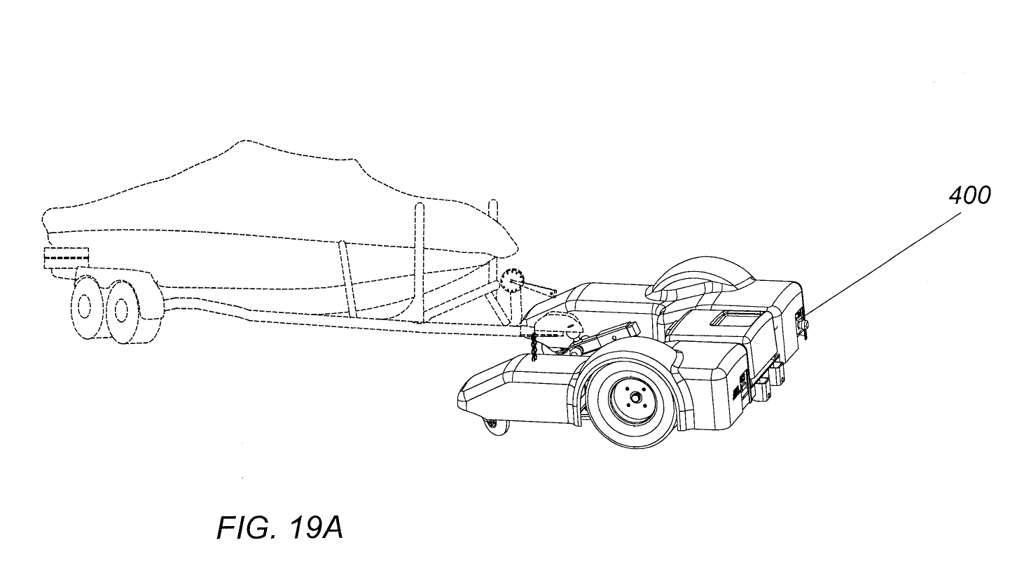

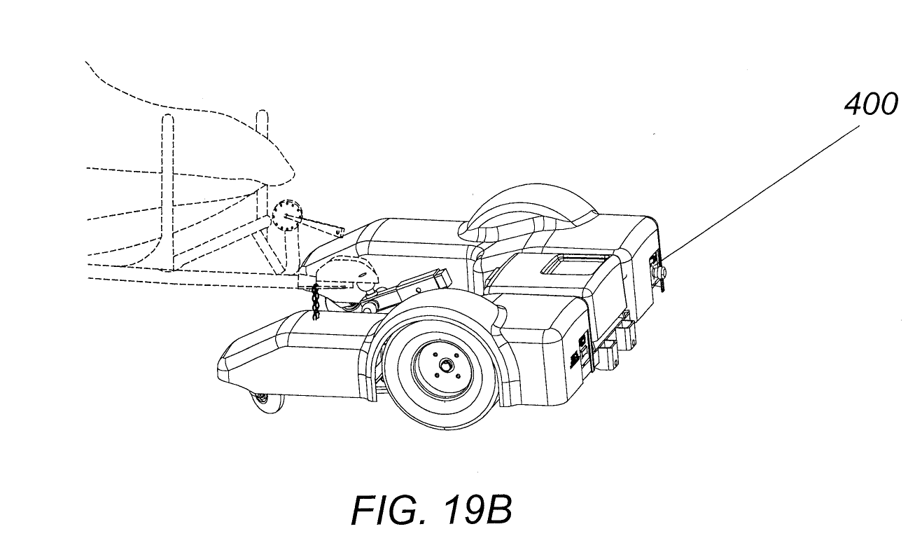

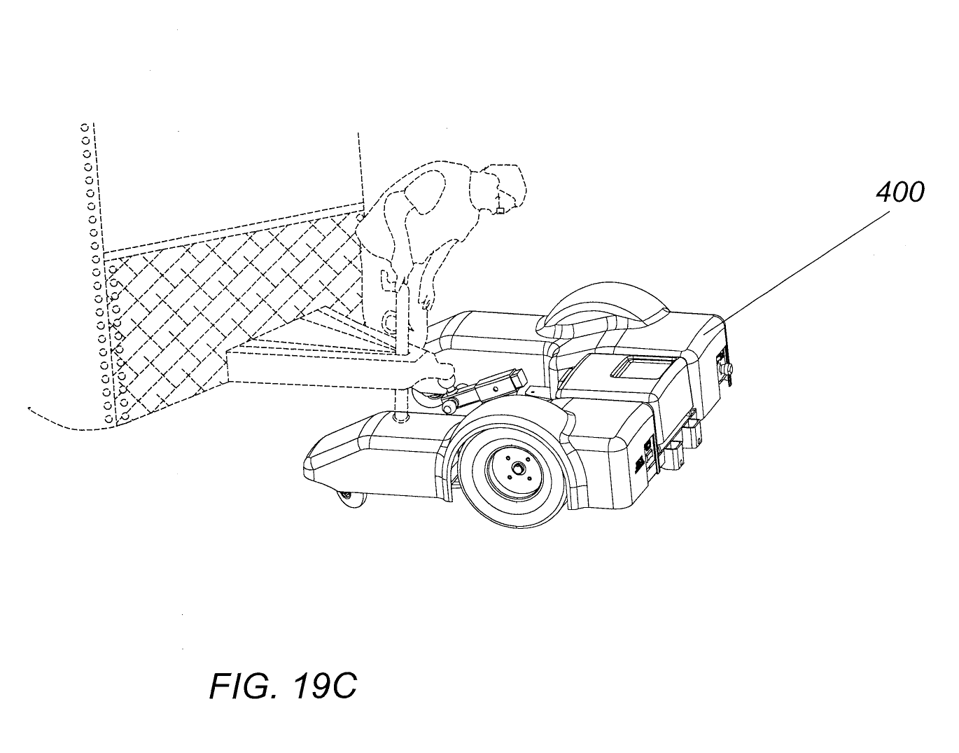

FIG. 17 illustrates an alternative embodiment of the tugbot, and is generally referenced as tugbot 400. The tugbot 400 is designed to attach to other non-aviation types vehicle. Such device allows a user to position non-aviation type vehicles within a confined showroom area with limited space or for conventional type tractors to operate easily. The tugbot 400 contains the same internal components, i.e. same drive system components and hydraulic systems, and functions in the same manner as tugbot 10. While the tugboat 10 was illustrated as engaging aviation devices, i.e. airplanes, the tugbot 400 is designed to engage other vehicles such as RVs. The tugbot 400 incorporates a vertical support structure 410 along the centerline of the lift plate 412. The vertical structure support 410 supports and provides three different vertically adjustment positions for the receiver post 414 by means of a series of three holes 416 on the support 410 and four holes 418 on the receiver post 414, see FIG. 18. As an illustrative example, the increments of adjustment are 1.25″ vertically. The receiver post 414 is secured with two steel pins aligned through not less than two of the support and receiver post holes simultaneously. A ball hitch, illustrated herein as a multi hitch ball mount 420 is secured into the receiver post 414 with a steel pin. A vehicle, such as a boat 426 or RV or car with trailer 428, can be driven up to the tongue of a the boat or trailer/RV where the hydraulic system 422 is activated, lifting the plate and the ball hitch to engage the tongue of the trailer to raise the dolly/landing jack clear of the ground for movement. Once the trailer/RV is positioned where it is desired, the hydraulic plate is lowered; and the ball hitch disengages the tongue as the dolly/landing jack contacts the ground, see FIGS. 19A-C.

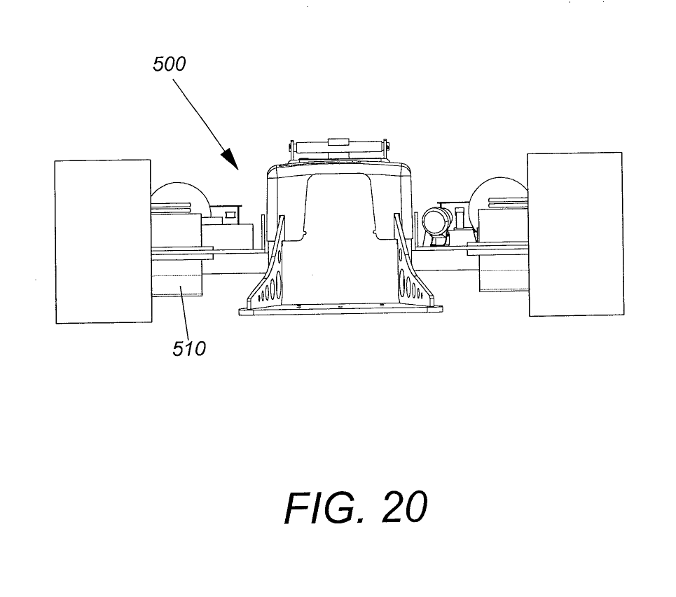

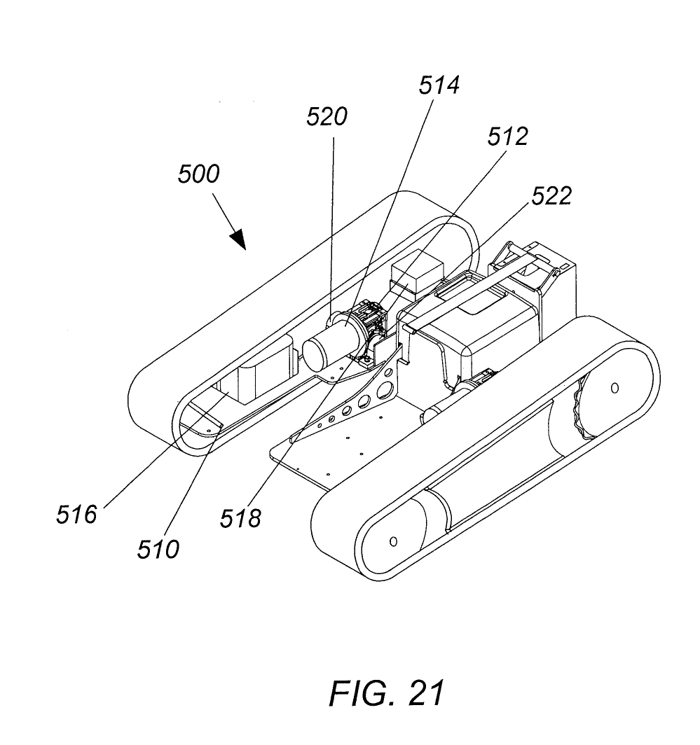

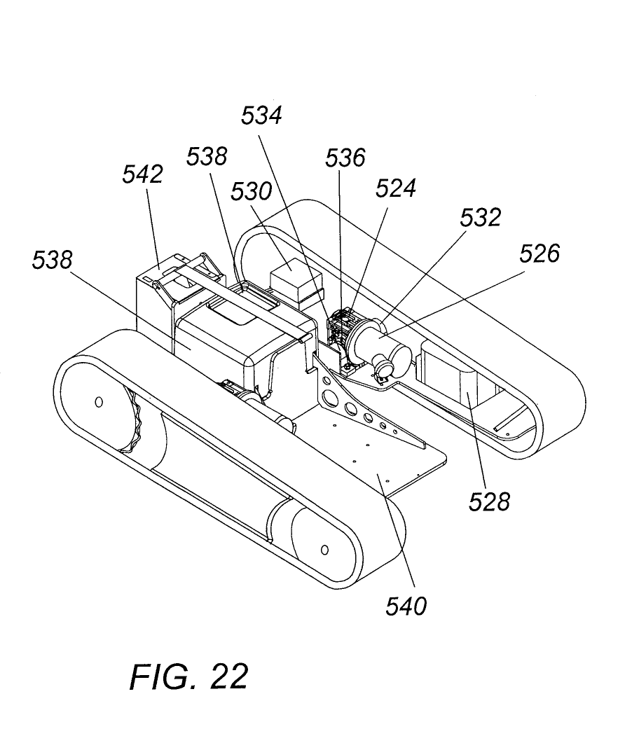

FIGS. 20-23 illustrate an alternative embodiment of the tugbot, illustrated herein as a tracbot 500. The tracbot 500 contains the same internal components, i.e. same drive system components and hydraulic systems, and functions in a similar manner as tugbot 10 or tugbot 400. As illustrated in FIG. 20, the tracbot 500 contains a chassis 510 which supports each of the independent drive systems. Referring to FIG. 21, the right drive system comprises a right side gear box 512 coupled to a right side motor 514, a right side battery 516, and a charging device 518. As described for the tugbot 10, two pillow block bearings 520 and 522 are used to minimize damage to the gear box 512. FIG. 22 illustrates the left side components of tracbot 500, including a left side gear box 524 coupled to a right side motor 526, a right side battery 528, and a main control unit 530. Two pillow block bearings 532 and 534 coupled to an axle 536 are used to minimize damage to the gear box 524.

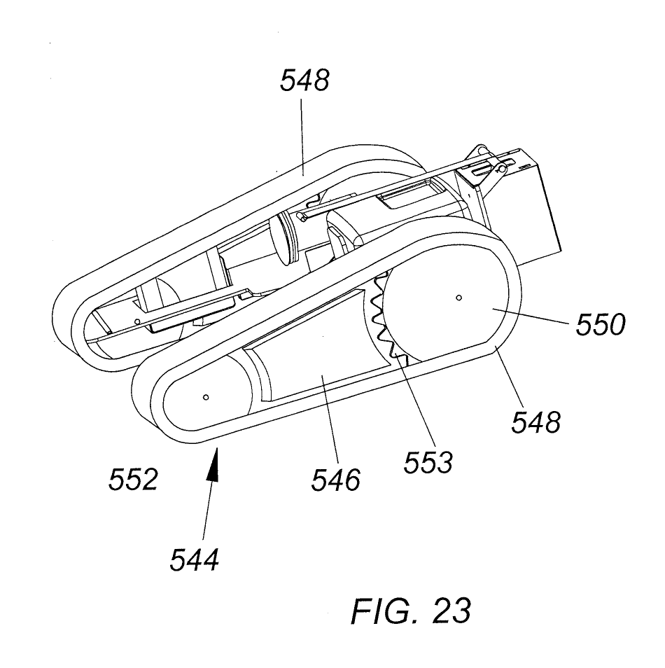

The tracbot 500 further contains a hydraulic system cover 538 for housing the hydraulic system components, as described previously, for providing lift to a lift plate 540. A winch system 542, having the same components as described previously, is coupled to the chassis 510. FIG. 23 illustrates the main difference between tugbots 10 and 400 and tracbot 500. The tracbot 500 is designed to contain a track wheel system, such as a continuous track system 544 in which the vehicle movement is driven by one or more modular plates 546 coupled to a continuous band 548 driven by two or more wheels, 550 and 552. The continuous band 548 of the tracbot is designed to provide movement in rough weather conditions, such as snow, ice and turf, while not damaging surfaces such as those surfaces associated with aviation hangers or storage areas. The continuous band 548 may contain teeth (not illustrated), such as but not limited to trapezoidal teeth or curvilinear teeth, to aid in maintaining contact with 550 and 552 which align with or secure to teeth 553 of wheel 550.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A towing device for towing a transportation vehicle or other moving vehicle comprising:
a chassis constructed and arranged to support one or more internal and/or external components of a non-manned towing device for towing a transportation or other moving vehicle;
a first wheel drive system assembly adapted to provide the towing device movement;
a second wheel drive system assembly to provide the towing device movement;
a plurality of secondary wheels;
a coupling member for coupling one or more portions of a transportation or other moving vehicle to said towing device, said coupling member adapted to lift a portion of said coupled transportation or other moving vehicle thereto from a first position to a second position; and
a main control unit;
wherein said towing device is adapted to provide a non-manned device for moving said transportation vehicle or other moving vehicle.

2. The towing device for towing a transportation vehicle or other moving vehicle according to claim 1 wherein said first and said second wheel drive system assemblies are independently controlled.

3. The towing device for towing a transportation vehicle or other moving vehicle according to claim 1 wherein said secondary wheels are castor wheel assemblies.

4. The towing device for towing a transportation vehicle or other moving vehicle according to claim 1 wherein said main control unit includes a microcomputer to perform motion control algorithms.

5. The towing device for towing a transportation vehicle or other moving vehicle according to claim 4 wherein said algorithms are designed to proportion the amount of power to each said wheel drive system assembly.

6. The towing device for towing a transportation vehicle or other moving vehicle according to claim 4 wherein the proportions of power to the first wheel drive system assembly differs from the proportion of power delivered to the second wheel drive system assembly, said different proportions results in a first primary wheel of said first wheel drive system assembly rotating at a different speed than a first primary wheel of said wheel drive system assembly and allowing said towing device to turn in a plurality of directions.

7. The towing device for towing a transportation vehicle or other moving vehicle according to claim 1 wherein said towing device is controlled by a handheld unit, said hand held unit adapted to provide remote functioning.

8. The towing device for towing a transportation vehicle or other moving vehicle according to claim 1 wherein said transportation vehicle or other moving vehicle coupling member is a lifting plate.

9. The towing device for towing a transportation vehicle or other moving vehicle according to claim 1 wherein said transportation vehicle or other moving vehicle coupling member is a hydraulic lifting plate.

10. The towing device for towing a transportation vehicle or other moving vehicle according to claim 1 further including a sensor.

11. The towing device for towing a transportation vehicle or other moving vehicle according to claim 10 wherein said sensor is electrically coupled to said control unit and adapted to sense a load upon said lifting plate, wherein sensing of a predetermine load value results in reduction of power to said first and second wheel drive system assemblies.

12. The towing device for towing a transportation vehicle or other moving vehicle according to claim 1 wherein said transportation device or other moving vehicle securing device is a hitch.

13. The towing device for towing a transportation vehicle or other moving vehicle according to claim 12 wherein said hitch is adjustable.

14. The towing device for towing a transportation vehicle or other moving vehicle according to claim 12 wherein said hitch is a ball hitch.

15. The towing device for towing transportation vehicle or other moving vehicle according to claim 1 further including a winch assembly.

16. The towing device for towing transportation vehicle or other moving vehicle according to claim 1 further including a securing device adapted to secure one or more portions of said coupled transportation or other moving vehicle to said towing device.

17. The towing device for towing transportation devices or other moving vehicles according to claim 16 wherein said securing device includes a hook or clasp.

18. The towing device for towing transportation devices or other moving vehicles according to claim 1 further including a light.

19. The towing device for towing a transportation vehicle or other moving vehicle according to claim 1 wherein said first wheel drive system assembly and said wheel drive system assembly include a track.

20. The towing device for towing a transportation vehicle or other moving vehicle according to claim 19 wherein said at least two tracks are continuous tracks.
